(19) United States
(12) Patent Application Publication
(10) Pub. No.: US 2009/0235178 A1
(43) Pub. Date: Sep. 17, 2009

(54) METHOD, SYSTEM, AND COMPUTER PROGRAM FOR PERFORMING VERIFICATION OF A USER

(75) Inventors: Marco Cipriani, Rome (IT); Filomena Ferrara, Rome (IT); Scot Maclellan, Rome (IT); Favio Pinzauti, Rome (IT)

Correspondence Address: OPPENHEIMER, WOLFF & DONNELLY, LLP, PLAZA VII, SUITE 3300, 45 SOUTH SEVENTH STREET, MINNEAPOLIS, MN, 55402-1609, US

(73) Assignee: International Business machines Corporation, Armonk, NY (US)

(21) Appl. No.: 12/256,103

(22) Filed: Oct. 22, 2008

(30) Foreign Application Priority Data
Mar. 12, 2008 (EP) 08152642.8

(51) Int. Cl. G06F 21/00; G06F 3/048

(52) U.S. Cl. 715/741

(57) ABSTRACT

One aspect of the present invention provides a mechanism for recognizing and distinguishing between human would-be users of websites and automated agents attempting to gain unauthorized access to the website. More particularly, when a website server receives a registration request from a would-be user, a distorted image of a common object (e.g. a house, cat, etc.) is generated. The distorted image is shown to the would-be user, and the user must insert the correct name of the object depicted in the image to gain access to the website. By placing a limit on the time interval in which a user can provide a correct identification of the displayed object, this embodiment attempts to harness the conceptual and cognitive reasoning facilities of human users to distinguish them from automated agents. The challenge to the user is enhanced by restricting the correct identification to the language of the browser viewing the website.

### FIELD OF THE INVENTION

The present invention relates to a method, system, and computer program for verifying that a user is a human being instead of an automated agent.

### BACKGROUND OF THE INVENTION

The use of automated agents to gain unauthorized access to websites is an ever-increasing problem. For instance, automated registration techniques may be used by hackers in DoS (denial of service) attacks on websites. Furthermore, large-scale unauthorized access to websites which transmit an SMS message to users after registration can result in the flooding of telecommunication networks by a huge number of SMS messages. Automated agents have made it easier for hackers to launch large-scale disruptive attacks on websites, by effectively automating the hacking process.

Traditional mechanisms for distinguishing between human users and automated agents (attempting to gain access to a website) are typically based on the presentation of textual challenges to the would-be user. In particular, these systems construct a string comprising letters and/or numbers, form an image of the string, and then distort the image. The systems then present the image to the would-be user and request the user to essentially reproduce the string contained therein. However, these prior art human verification systems have limited use, insofar as individual characters in a string can only be distorted by a limited amount, if the characters therein are still to be recognizable by a user. For example, a very limited amount of distortion can be applied to the letter “m” if it is to be distinguished from the letter “w”.

Furthermore, these traditional human verification systems do not make full advantage of the cognitive reasoning facilities of human beings. In particular, since the answer to the challenge presented to the would-be user is inherently a string, the challenge presented to the user does not avail of their ability to extrapolate from, and apply abstract reasoning to, the challenge.

Existing systems have attempted to overcome these limitations with limited success. US Patent Publication No. 2004/0199597 describes a method and system for image verification to prevent messaging abuse. More particularly, US 2004/0199597 describes a generic verification system in which a challenge response mechanism plays a role. However, US 2004/0199597 does not describe the process by which the challenge to a would-be user is effectively created.

Similarly, U.S. Pat. No. 6,195,698 describes a method for selectively restricting access to computer systems. In particular, this patent describes a challenge response mechanism for preventing automated agents from accessing the services or resources. However, the method described in U.S. Pat. No. 6,195,698 is based on the concept of textual string representation, and is subject to the limitations described above.

### BRIEF SUMMARY OF THE INVENTION

One aspect of the present invention provides an operation for verifying that a prospective user of a website is human. In one embodiment, this operation comprises the steps of: selecting a graphics image from an image repository, with this graphics image depicting an object; distorting the image; presenting the image to the user; requesting the user to identify, within a pre-defined time interval, the object depicted in the image; determining that the user is a human in the event the user correctly identifies the object within the pre-defined time interval; and allowing the user to gain access to the website in the event that the user is determined as being human.

By placing a time limit on the time interval in which a user can provide a correct identification of a displayed object, this embodiment attempts to harness the conceptual and cognitive reasoning facilities of human users to distinguish them from automated agents.

According to a further embodiment of the present invention, additional steps are performed, including: interrogating a browser of the user to determine the language with which the browser is configured; retrieving a name of the object from a dictionary of a language that matches the language of the browser; and determining that the user is human, in the event the user provides, within the pre-defined time interval, a name which matches the name of the object that is retrieved from the dictionary.

By utilizing the specific language of the user's browser, this embodiment further harnesses the associative linguistic reasoning of human users to distinguish them from automated agents.

### BRIEF DESCRIPTION OF THE DRAWINGS

Various embodiments of the invention are herein described by way of example, with reference to the accompanying Figures in which:

FIG. 1 depicts a flowchart of a method for verifying that a prospective user of a website is human according to one embodiment of the present invention;

FIG. 2 depicts a picture of an exemplary graphic presented to a user to verify that a prospective user of a website is human according to one embodiment of the present invention; and

FIG. 3 depicts a block diagram of a computer system adapted to support a method for verifying that a prospective user of a website according to one embodiment of the present invention.

### DETAILED DESCRIPTION OF THE INVENTION

In one embodiment of the present invention, when a server (hosting a website) receives a registration request from a would-be user, a distorted image is generated (for example, a house, cat, bird, cake, or hand). The distorted image is then shown to the would-be user, and the user must provide the correct name of the object depicted in the image to gain access to the website. At the heart of this embodiment is the observation that humans are typically capable of much faster pattern recognition and abstract conceptual reasoning than even the most sophisticated automated pattern recognition systems currently available. Accordingly, a human being will typically recognize a distorted image much faster than any of these sophisticated pattern recognition systems. Additionally, by placing a time limit on the time interval in which a user can provide a correct identification of a displayed object, this embodiment attempts to harness the conceptual and cognitive reasoning facilities of human users to distinguish them from automated agents.

The challenge to the user is further enhanced by restricting the correct identification to the language of the internet browser which issued the challenge. Restated, if the user's browser was configured for the Chinese language, then the user, on attempting to gain access to the required website, would be required to provide the name of the displayed object in the Chinese language.

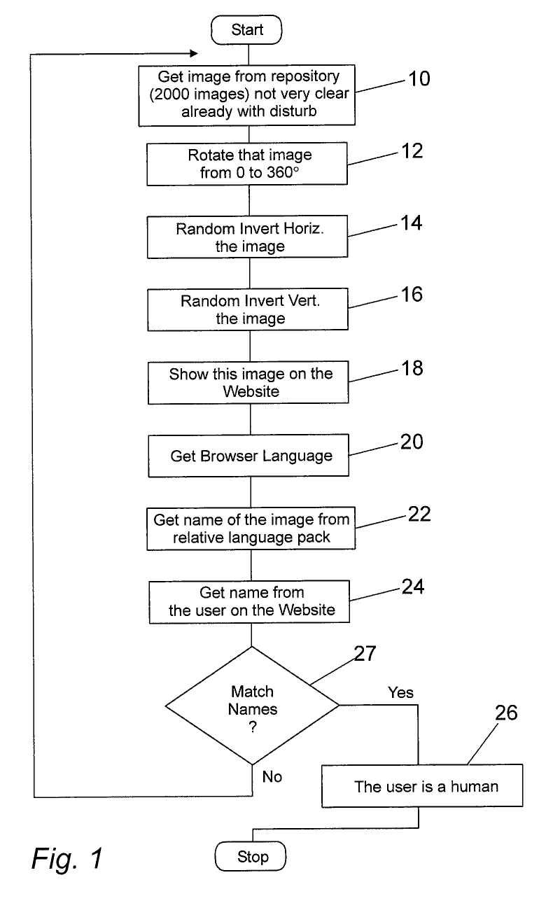

FIG. 1 illustrates a flowchart of a method for verifying that a prospective user of a website is human according to one embodiment of the present invention. On receipt of a request to register with or access a particular website, an image is retrieved 10 from a repository of a number of previously stored images. As suggested in FIG. 1, the number of images is fairly large, for example, 2000. These previously stored images are already unclear and slightly distorted, containing noise and similar distortion effects. The image is then rotated 12 to an angle randomly selected from the range of 0-360 degrees. In this embodiment, a random selection of whether or not to flip the image 14 about its horizontal axis occurs. This embodiment also performs a random selection of whether or not to flip the image 16 about its vertical axis. Further noise may or may not be added to the image at this point. Similarly, a portion of the image may or may not be selected for display to the user. The resulting graphic is then shown 18 on the website to the would-be user.

In a further embodiment, the browser of the would-be user is queried to determine 20 the language with which the browser has been configured. After determining which language to use, the name of the image depicted in the graphic is retrieved 22 from a language pack which matches the language of the user's browser. The user is then requested to provide the name of the depicted object, and the name provided by the user is retrieved 24. If the name provided by the user matches 27 the name retrieved from the language pack, the operation determines that the user is a human 26 and allows the user to complete their registration with the website. However, if the name provided by the user does not match 27 the name retrieved from the language pack (or the user does not provide a name within a pre-defined time limit), the process is repeated. Another image containing the above-mentioned distortions is retrieved from the repository 10, and the process is repeated by presenting this next object to the user to be identified.

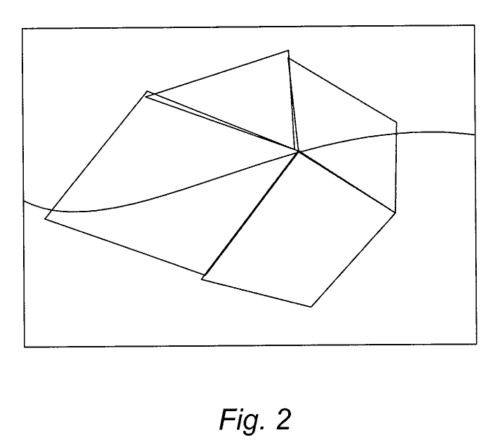

FIG. 2 provides an example of a distorted image of a house that might be presented to a user in accordance with one embodiment of the present invention. In this case, if the user is Italian and the user's browser is configured for the Italian language, the user must enter the word “casa”. Alternatively, if the user's browser is configured for English, then the user must provide the string “house.”

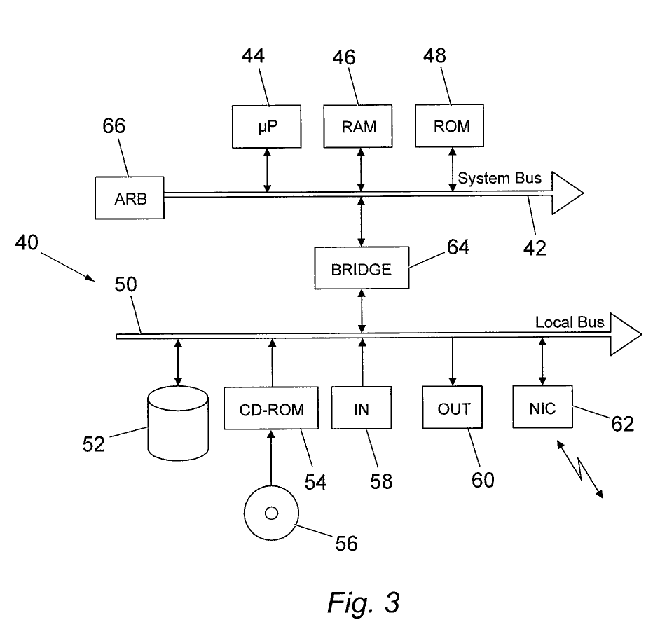

FIG. 3 illustrates a generic computer system 40 adapted to support the various embodiments of the present invention. This computer system 40 is formed by several units that are connected in parallel to a system bus 42. In detail, one or more microprocessors (μP) 44 control operation of the computer 40; a RAM 46 is directly used as a working memory by the microprocessors 44, and a ROM 48 stores basic code for a bootstrap of the computer 40. Peripheral units are clustered around a local bus 50 (by means of respective interfaces). Particularly, a mass memory consists of a hard disk 52 and a drive 54 for reading CD-ROMs or similar media 56. Moreover, the computer 40 includes input devices 58 (for example, a keyboard and a mouse), and output devices 60 (for example, a monitor and a printer). A Network Interface Card (NIC) 62 is used to connect the computer 40 to a network. A bridge unit 64 interfaces the system bus 42 with the local bus 50. Each microprocessor 44 and the bridge unit 64 can operate as master agents requesting an access to the system bus 42 for transmitting information. An arbiter 66 manages the granting of the access with mutual exclusion to the system bus 42.

Similar considerations apply if the system has a different topology, or it is based on other networks. Alternatively, the computers have a different structure, including equivalent units, or consist of other data processing entities (such as PDAs, mobile phones, and the like).

Although various representative embodiments of this invention have been described above with a certain degree of particularity, those skilled in the art could make numerous alterations and modifications to the disclosed embodiments without departing from the spirit or scope of the inventive subject matter set forth in the specification and claims.

1. A method for verifying that a prospective user of a website is human, comprising:
selecting, from an image repository, a graphics image depicting an object;
distorting the image;
presenting the image to the user;
prompting the user to identify, within a pre-defined time interval, the object depicted in the image;
determining that the user is human responsive to the user correctly identifying the object within the pre-defined time interval; and
allowing the user to gain access to the website responsive to determining that the user is human.

2. The method as claimed in claim 1, further comprising repeating the steps of the method responsive to the user failing to correctly identify the object within the pre-defined time interval.

3. The method as in claim 1, further comprising:
querying a browser of the user to determine the language with which the browser is configured; and
retrieving a name of the object from a dictionary of a language that matches the language of the browser;
wherein correctly identifying the object further comprises providing, by the user within the pre-defined time interval, a name which matches the name of the object retrieved from the dictionary.

4. The method as in claim 1, wherein the step of distorting the image comprises the step of rotating the image by an angle randomly selected from the range of 0 to 360 degrees.

5. The method as in claim 1, wherein distorting the image comprises:
determining, on a random basis, whether to invert the image about a horizontal axis thereof; and
inverting the image about its horizontal axis responsive to randomly determining to invert the image.

6. (canceled)

7. The method as in claim 1, wherein the step of presenting the image to the user comprises the steps of:
randomly selecting a portion of the image; and
presenting the selected portion to the user.

8. A system, comprising:
at least one processor; and
at least one memory storing instructions operable with the at least one processor for verifying that a prospective user of a website is human, the instructions being executed for:
selecting, from an image repository, a graphics image depicting an object;
distorting the image;
presenting the image to the user;
prompting the user to identify, within a pre-defined time interval, the object depicted in the image;
determining that the user is human responsive to the user correctly identifying the object within the pre-defined time interval; and
allowing the user to gain access to the website responsive to determining that the user is human.

9. A computer program product comprising a computer useable medium having a computer readable program for verifying that a prospective user of a website is human, wherein the computer readable program when executed on a computer causes the computer to:
selecting, from an image repository, a graphics image depicting an object;
distorting the image;
presenting the image to the user;
prompting the user to identify, within a pre-defined time interval, the object depicted in the image;
determining that the user is human responsive to the user correctly identifying the object within the pre-defined time interval; and
allowing the user to gain access to the website responsive to determining that the user is human.

10. A service deployed in a data processing system for performing a method of verifying that a prospective user of a website is human, comprising:
selecting, from an image repository, a graphics image depicting an object;
distorting the image;
presenting the image to the user;
prompting the user to identify, within a pre-defined time interval, the object depicted in the image;
determining that the user is human responsive to the user correctly identifying the object within the pre-defined time interval; and
allowing the user to gain access to the website responsive to determining that the user is human.

11. The method as in claim 1, wherein the step of distorting the image comprises the steps of:
determining on a random basis whether to invert the image about a vertical axis thereof;
and inverting the image about its vertical axis responsive to randomly determining to invert the image.
